(19) United States
(12) Patent Application Publication
(10) Pub. No.: US 2014/0265235 A1
(43) Pub. Date: Sep. 18, 2014

(54) Bicycle Training Stabilizing Device

(71) Applicant: Douglas G. Staab, Cornelius, NC (US)

(72) Inventor: Douglas G. Staab, Cornelius, NC (US)

(21) Appl. No.: 13/844,913

(22) Filed: Mar. 16, 2013

(51) Int. Cl. B62J 99/00

(52) U.S. Cl. CPC B62J 99/00
USPC 280/293

(57) ABSTRACT

A manual stabilizing device is designed to be used and operated by a person positioned adjacent a bicycle being ridden by another person, such as a child. The inventive device includes an elongated handle and an engaging jaw that allow a user to grab or connect with an element of a bicycle frame at the time of use without previously adding or permanently securing any other device to the bicycle. An operator controlled handle or lever controls the engaging jaw to capture or release a portion of the bicycle frame to allow the user to apply stabilizing forces to the bicycle.

### BACKGROUND OF THE INVENTION

The present invention pertains to devices for stabilizing bicycles during rider training and practice. In particular, the device addresses devices to be manually controlled by a human user who is positioned adjacent a bicycle and provides stabilization to the bicycle while it is ridden by another person.

The prior art includes various devices for a user to stabilize a bicycle while it is ridden by another person. Typically these prior devices must be rigidly secured to a bicycle during use and consequently suffer from a variety of detriments including added weight and the inherent necessity of their prior installation before use. What is desired is an easily used bicycle-stabilizing device that may be immediately used to engage and hold a bicycle without prior modification or attachment to the bicycle.

### SUMMARY OF THE INVENTION

The invention is a manual stabilizing device designed to be used and operated by a person positioned adjacent to a bicycle being ridden by another person, such as a child. The device includes an elongated handle and an engaging jaw that allow the user to grab or connect with the bicycle at the time of use without previously adding or rigidly securing any other device to the bicycle. An operator controlled handle or lever controls the engaging jaw to capture or release an elongated portion of the bicycle frame to allow the user to apply stabilizing forces to the bicycle. The jaw provides a loose fit with the bicycle frame to accommodate changes in orientation and position of the inventive device handle relative to a bicycle during use. This loose-fit aspect also provides comfortable use by persons of varying heights as each may manually operate the device at a respective natural attitude and hand position without altering the function of the device.

The inventive device allows a training user to comfortably walk or jog a safe distance from a bicycle rider while controlling the rider's balance. Ideally, in use the trainer stands at a 30 to 60 degree angle behind the rider to best stabilize the balance forces. The device is designed to allow the bicycle to move in all directions during use, so the trainer user may move further behind the rider to push them up a hill or simply switch hands or stand in one position while the rider makes a U-turn.

The inventive device is the only bike training device that is a universal, one piece unit that requires no installation or bike modification or other prior bicycle-secured device in order to operate. Additional novel aspects and benefits of the invention will be discerned from the following description of particular embodiments and the accompanying figures.

### DESCRIPTION OF THE DRAWINGS

FIG. 1 is a perspective illustration of the inventive device in a mode of application with a subject bicycle.

FIG. 2 is a perspective view of the inventive device.

FIG. 3 is an enlarged detailed illustration of some of the operable elements of the invention.

FIG. 4 is an enlarged detailed illustration of the handle and operator elements of the inventive device.

### DETAILED DESCRIPTION OF EMBODIMENTS OF THE INVENTION

FIGS. 1 to 4 depict a common configuration of the invention and illustrate some of its inventive aspects. The invention provides a bicycle stabilizing device 10 that is manually operable by a human user located at infinitely variable positions about the object bicycle.

The stabilizing device 10 includes an elongated handle 12 that serves as means of allowing a human user to transmit stabilizing forces to the subject bicycle. In particular, the elongated handle 12 is configured to allow transmitting force to an elongated bicycle frame element, while the bicycle is in motion, from various locations behind or beside the bicycle. In FIG. 1, the inventive stabilizing device 10 is illustrated loosely and removably secured to the seat post element of a subject bicycle. The handle 12 extends from the bicycle at an angle from the axis of the bicycle and its line of motion. Because the inventive means of securing the device 10 to the bicycle allows relative rotational adjustment and variability, the user may be located at a variety of positions around the bicycle. This allows flexibility of use and adjustment to the user's abilities and the surrounding environment and changing dynamics of bicycle movements.

FIG. 2 illustrates the same stabilizing device 10. Its elongated handle 12 has a distal end 13 where the elongated handle 12 terminates with a means of loosely securing the handle 12 to a bicycle. In use, a user may need to secure the device 10 to a bicycle while the bicycle is unsteady, therefore the means of securing must be easily engaged with the bicycle for easy and quick securing. At the same time, the stabilizing device 10 must be easily disengaged during use while the associated bicycle, and the user handling the stabilizing device 10, is moving. For these purposes, in this configuration the means of securing includes a rigid open or slotted jaw member 16 that is rigidly secured to, or integral with, the handle 12 at the distal end 13. The jaw member 16 has a slotted jaw opening 20 with an effective width dimension 22 preferably in the range of 1.0 to 2.0 inches (25.4 to 51 millimeters). This dimension is effective to capture typical bicycle frame elements which may vary in diameter in the range of about 0.50 inches to 1.125 inches (12 to 29 millimeters). The shape of the jaw member slot and opening is not critical and the slot, as an open receptacle for a bicycle frame element, may comprise parallel opposing sides or angled sides that diverge outward as well as other equivalent configurations.

A rigid closing bar 18 is pivotably attached to the jaw member 16 such that it may be rotated alternatively into one of two conditions: the first where the jaw opening 20 is unobstructed such as to allow, in use, entry into the opening 20 of some portion of a bicycle frame. In the second condition, the closing bar 18 is pivoted to cross and block the jaw opening 20 to capture any frame portion within the jaw member 16. In this second condition, a user may transmit forces in any horizontal direction through the handle 12 and hence through the jaw member 16 and closing bar 18 to the captured bicycle frame portion. At any time and instant, the user may also release the bicycle by rotating the closing bar 18 to the first, open, condition, to allow the frame portion to exit the jaw opening 20. In FIG. 2, the closing bar 18 is in the second, closed condition. It is an essential element of the invention that the jaw member 16 and closing bar 18 are sized and operate to engage the frame portion in a relatively loose manner to allow for relative rotation between the handle 12 and bicycle frame during use. In this manner, relative positioning of the user relative to the bicycle is allowed without generating unwanted forces. At the same time, the stabilizing device 10 is operable by the user to transmit stabilizing forces to the bicycle by pulling or pushing on the handle along its axis. For this reason, the inventive device should not be configured to rigidly connect to a portion of the bicycle.

It is important that the jaw member 16 and closing bar 18 together have a effective thickness dimension 33 (FIG. 2) small enough that they do not bind on a captured bicycle frame element, but allow free movement of the handle 12 proximal end 30. Both side-to-side and vertical movement 34 (FIG. 1) of the handle proximal end 30 is critical for effective and comfortable use. Free movement of the handle 12 both accommodates various users of different heights and allows adjustment of the user's position adjacent a bicycle when in use. Free movement is intended to indicate movement that does not induce substantial moments in the jaw member 18. Experimentation has found that a fit that provides free movement at the proximal end 30 of at least 18 inches (both side-to-side and vertical) is required for handles having a length of 48 inches. Movement in the range of 18 inches to 24 inches is acceptable. The appropriate movement for similar devices have different overall length will be proportional to length. Significantly greater movement may prevent effective transfer of stabilizing force from the user. The appropriate thickness dimension is somewhat dependent on the clearance or gap between the opening 20 and the captured frame element.

To enable a user to operate the closing bar 18 as discussed above, the handle 12 includes an operator 31 including an operator lever 32 that is located within the handle 12 adjacent a proximal end 30 of the handle 12 (FIG. 4). The lever 32 extends outside the handle 12 for access and operation by a user. The handle 12 includes a side slot for this purpose. The handle 12 is hollow from the operator 31 to the distal end 13, to allow passage of a linkage 34 that connects the operator 31 to the closing bar 18. Movement of the operator 31 by a user functions to move the closing bar 18, alternatively, to it respective conditions. Both the operator 31 and the linkage 34 may take any of various different forms. The linkage 34 may be flexible or rigid; if flexible, a return spring (not shown) may be required to provide movement. The return spring should be configured to bias the stabilizing device 10 into the closed condition, while user operation against the spring force is used to move the closing bar into the open condition. In this way, during stabilizing activities, the user need not be distracted by any effort to maintain the closed condition.

The stabilizing device 10 is designed to help train a child or other rider how to ride a bicycle. It may be hooked onto any rigid part of the bike that the user can engage and that doesn't interfere with the rider or their safety, preferably; the seat neck or adjacent frame post or the rear fork above the wheel. In a preferred exemplary mode of operation, the user connects the stabilizing device 10 onto the bicycle by moving the open jaw member 16 over a bicycle frame element. The closing bar 18 is then allowed to move into the closed condition, thereby connecting the device to the bicycle. The rider gets on the bicycle and the user moves together with the rider on the bicycle while the user holds the stabilizing device 10 comfortably in his hands. If desired, the user may release the bicycle by operating the lever 32 and opening the jaw member 16 to allow the captured bicycle frame portion out, thereby disconnecting the stabilizing device 10.

The elements of the stabilizing device 10 may be made substantially of metal. However, it may be made of any material that can withstand the moments and forces produced by the weight of a particular subject rider on a select bicycle.

The stabilizing device 10 has a preferred overall length of about 48 inches although lengths in the range of 36 to 72 inches may be effective depending on the dimensions of the bicycle and the size of the user. Preferably, one or more hand-grips are provided on the handle 12 for the convenience and ease of use. The structure and function of the operator 31 and lever 32 are preferably provided by a spring-loaded lever with a hand-trigger opening mechanism similar to a bicycle brake lever. The configuration shown includes a handle 12 with a configuration having a thirteen degree bend to help manage the operating forces. However, none of these features are required. It may be configured with any bend angle or no bend angle if the material strength allows it to withstand the moment forces and it comfortably fits into the user's hands at a natural and unforced height. It can use any type of opening mechanism and any type of closing mechanism that is effective for the same purpose and function.

The preceding discussion is provided for example only. Other variations of the claimed inventive concepts will be obvious to those skilled in the art. Adaptation or incorporation of known alternative devices and materials, present and future is also contemplated. For example, the structure and function of the engaging jaw element 16 and closing bar 18 may be provided by a pair of operable jaw elements. Other alternatives are also contemplated. The intended scope of the invention is defined by the following claims.

1. A bicycle stabilizing device comprising:
an elongated rigid handle having a first and second end;
an open slot at the first end;
a closing means for closing the slot to prevent escape of a bicycle frame element located within the slot, the closing means biased into a closed condition wherein the slot is closed;
the handle including an operator means at the second end for operating and opening the slot.

2. A device, according to claim 1, and wherein:
the slot has a opening width dimension in the range of one to two inches.

3. A bicycle stabilizing device comprising:
an elongated rigid handle having a first and second end and an engaging jaw at the first end;
an engaging jaw configured to enable the engaging jaw to loosely capture a bicycle frame element such that forces applied to the handle may be transmitted to the frame element while the second end is easily moved in two orthogonal directions;
an operator located on the handle between the first end and the second end, the operator configured to manipulate the jaw to enable release of a captured frame element.

4. A device, according to claim 3, and wherein:
the second end may be moved over a range of 18 inches without transmitting force to the jaw.

5. A device, according to claim 3, and wherein:
the jaw includes a slot and a rigid closing bar element, the closing bar operable to, alternatively: block the slot to capture a bicycle frame element within the slot, and open the slot to allow release of a captured frame element.

6. A device, according to claim 5, and wherein
the operator comprises:
a hand-operable lever pivotable secured to the handle, and
a linkage connecting the lever to the closing bar element;
such that movement of the lever operates the closing bar.
